(19) United States
(12) Patent Application Publication
(10) Pub. No.: US 2015/0256982 A1
(43) Pub. Date: Sep. 10, 2015

(54) METHOD AND APPARATUS FOR PROVIDING MOBILE BROADCASTING SERVICE OVER CABLE BROADCAST NETWORK

(71) Applicant: Electronics and Telecommunications Research Institute, Daejeon (KR)

(72) Inventors: Joon Young JUNG, Daejeon (KR); Dong Joon CHOI, Daejeon (KR); Namho HUR, Sejong (KR); YONG SEONG CHO, Daejeon (KR)

(21) Appl. No.: 14/631,953

(22) Filed: Feb. 26, 2015

(30) Foreign Application Priority Data
Mar. 6, 2014 (KR) 10-2014-0026782

(51) Int. Cl. H04W 4/06; H04H 60/96; H04H 20/71; H04W 72/00; H04H 20/80

(52) U.S. Cl. CPC H04W 4/06; H04W 72/005; H04H 20/80; H04H 20/71; H04H 60/96

(57) ABSTRACT

A method and apparatus for providing a mobile broadcasting service over a cable broadcasting network are provided. A mobile broadcast signal and a cable broadcast signal are transmitted over the cable broadcast network. The cable broadcast signal and the mobile broadcast signal are filtered to pass the mobile broadcast signal, and the passed mobile broadcast signal is sent to a mobile broadcast terminal.

### CROSS-REFERENCE TO RELATED APPLICATION

This application claims priority to and the benefit of Korean Patent Application No. 10-2014-0026782 filed in the Korean Intellectual Property Office on Mar. 6, 2014, the entire contents of which are incorporated herein by reference.

### BACKGROUND OF THE INVENTION

(a) Field of the Invention

The present invention relates to a method and apparatus for providing a mobile broadcasting service on a cable broadcasting network.

(b) Description of the Related Art

Cable broadcasting networks, which were a means of reducing terrestrial broadcast fringe areas at the initial stage, have developed into independent broadcasting media with the advent of program providers and cable television system operators.

The cable broadcasting networks have developed into providers of two-way fast data services at the initiative of North America. That is, the advent of cable modems for cable broadcasting networks led to the development of integrated networks capable of dealing with both broadcasting and communications. A cable broadcasting network is a hybrid fiber coaxial cable broadcasting network, which can be deemed as a type of closed wireless network. In other words, the cable broadcasting network can be used as a broadcast network capable of transmitting RF signals in a band of frequencies from 54 MHz to 864 MHz.

In recent years, low-output regional mobile broadcasting services using terrestrial DMB have emerged. A low-power regional digital multimedia broadcast is a broadcast which is sent at low output power to a particular region (e.g., around a place where an event takes place) by using idle bands for existing digital broadcasts. To provide this service, a dedicated outdoor broadcasting VAN has to send 1 W of broadcast waves in the corresponding region, and viewers around the mobile unit can view the broadcast by searching through mobile broadcast channels.

However, it is expensive to provide a low-power mobile broadcasting service as a dedicated outdoor broadcasting VAN or signaling equipment needs to be set up in the corresponding region.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for providing a mobile broadcasting service over a cable broadcasting network.

An exemplary embodiment of the present invention provides a method for providing a mobile broadcasting service to a terminal. The method may include: generating a mobile broadcast signal using mobile broadcast content; generating a cable broadcast signal using cable broadcast content; transmitting the mobile broadcast signal and the cable broadcast signal over a cable broadcasting network; passing the mobile broadcast signal transmitted over the cable broadcasting network; and providing the passed mobile broadcast signal to the terminal.

The method may further include converting the cable broadcast content to generate the mobile broadcast content.

The mobile broadcast content may be directly provided by a program provider.

The providing of the passed mobile broadcast signal to the terminal may include: converting the frequency of the passed mobile broadcast signal; amplifying the frequency-converted mobile broadcast signal; and sending the amplified mobile broadcast signal to the terminal.

The mobile broadcast signal may be transmitted using part of the frequency range of the cable broadcasting network.

The mobile broadcast content may include in-store shopping information, and the terminal may display the shopping information.

The mobile broadcast content may be information related to the cable broadcast content.

Another exemplary embodiment of the present invention provides an apparatus for providing a mobile broadcasting service. The apparatus may include: a cable broadcast transmitter that generates a cable broadcast signal using cable broadcast content; and a mobile broadcast transmitter that generates a mobile broadcast signal using mobile broadcast content, wherein the cable broadcast signal and the mobile broadcast signal may be sent over a cable broadcasting network.

The apparatus may further include a mobile broadcast signal sending device that receives the mobile broadcast signal and provides the mobile broadcast signal to a terminal.

The mobile broadcast signal sending device may include: a band-pass filter that filters the cable broadcast signal and the mobile broadcast signal to pass the mobile broadcast signal; and an amplifier that amplifies the passed mobile broadcast signal.

The mobile broadcast signal sending device may further include a frequency converter that converts the frequency of the passed mobile broadcast signal and provides the frequency-converted mobile broadcast signal to the amplifier.

The apparatus may further include a set-top box that receives and demodulates the cable broadcast signal and provides the demodulated cable broadcast signal to a TV.

The mobile broadcast signal sending device may be set up indoors or outdoors.

Yet another exemplary embodiment of the present invention provides a method for providing a mobile broadcasting service to a terminal. The method may include: receiving a mobile broadcast signal and a cable broadcast signal over a cable broadcasting network; filtering the cable broadcast signal and the mobile broadcast signal to pass the mobile broadcast signal; and providing the passed mobile broadcast signal to the terminal.

The cable broadcast signal and the mobile broadcast signal may be transmitted at different bands in the frequency range for the cable broadcast network

One physical channel for the mobile broadcasting service may include a plurality of logical channels.

According to an embodiment of the present invention, it is possible to provide a mobile broadcast service in a predetermined region at low cost by using a cable broadcasting network.

In terms of frequency utilization, idle terrestrial broadcast frequencies can be utilized, and this provides coverage of mobile broadcast fringe areas, the diversification of mobile broadcast content, and the creation of additional services of cable television like a second service. Moreover, it can be expected that mobile broadcasting will become more widely adopted by interfacing with home shopping, large shopping malls, local broadcast stations, etc.

### BRIEF DESCRIPTION OF THE DRAWINGS

FIG. 1 is a view showing a broadcasting system according to an exemplary embodiment of the present invention.
(A) of FIG. 2 is a view showing a frequency range used in a general cable broadcasting network, and (B) of FIG. 2 is a view showing a frequency range that both a cable broadcast signal and a mobile broadcast signal use in a cable broadcasting network.

FIG. 3 is a view showing a concrete configuration of a mobile broadcast signal sending device according to an exemplary embodiment of the present invention.

FIG. 4 is a view showing a method for providing a mobile broadcasting service according to an exemplary embodiment of the present invention.

FIG. 5 is a view showing an example of providing a mobile broadcast home shopping service through a method for providing a mobile broadcasting service according to an exemplary embodiment of the present invention.

FIG. 6 is a view showing an example of providing a shopping assistance service in a department store or a hypermarket store through a mobile broadcasting service provision method according to an exemplary embodiment of the present invention.

FIG. 7 is a view showing an example of providing a menu guide service in a restaurant through a mobile broadcasting service provision method according to an exemplary embodiment of the present invention.

FIG. 8 is a view showing an example of providing a second screen service through a mobile broadcasting service provision method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, unless explicitly described to the contrary, the word “comprise” and variations such as “comprises” or “comprising” will be understood to imply the inclusion of stated elements but not the exclusion of any other elements.

Throughout this specification and the claims that follow, when it is described that an element is “coupled” to another element, the element may be “directly coupled” to the other element or “electrically coupled” to the other element through a third element.

A method and apparatus for providing a mobile broadcasting service according to an exemplary embodiment of the present invention provide a low-power mobile broadcasting service by sending a mobile broadcast signal over a cable broadcasting network. One example of mobile broadcasting may include DMB (Digital Multimedia Broadcasting). The exemplary embodiment of the present invention will be described below in detail.

FIG. 1 is a view showing a broadcasting system according to an exemplary embodiment of the present invention.

As shown in FIG. 1, the broadcasting system according to the exemplary embodiment of the present invention includes a cable broadcasting headend 100, a cable broadcasting network 200, and a service subscriber 300.

The cable broadcasting headend 100 transmits a cable broadcast signal and a mobile broadcast signal to the cable broadcasting network 200. The cable broadcast signal and mobile broadcast signal sent by the cable broadcasting headend 100 are transmitted at different broadcasting frequency bands to avoid interference with each other. The cable broadcast signal and the mobile broadcast signal are transmitted over the cable broadcasting network 200.

As shown in FIG. 1, the cable broadcasting headend 100 includes a digital media center 110, a cable broadcast transmitter 120, and a mobile broadcast transmitter 130.

The digital media center (DMC) 110 provides cable broadcast content. The cable broadcast content is transmitted to the cable broadcast transmitter 120 and the mobile broadcast transmitter 130.

The cable broadcasting transmitter 120 uses the corresponding broadcasting frequency band, modulates the cable broadcast content received from the DMC 110 into a cable broadcast signal, and sends the cable broadcast signal to the cable broadcasting network 200.

The mobile broadcast transmitter 130 according to the exemplary embodiment of the present invention converts the cable broadcast content received from the DMC 110 into a mobile broadcast video format to generate a mobile broadcast signal. The mobile broadcast signal is transmitted over the cable broadcasting network 200. The content input into the mobile broadcast transmitter 130 may be mobile broadcast content directly provided by a program provider or a local broadcast content created by a local broadcast station.

The cable broadcasting network 200 is a network that provides a cable broadcast signal to the service subscriber 300. The cable broadcasting network 200 according to the exemplary embodiment of the present invention transmits a mobile broadcast signal, as well as the cable broadcast signal, to the service subscriber 300.

The cable broadcast signal transmitted over the cable broadcasting network 200 is transmitted to a cable set-top box (STB) 310. The cable STB 310 demodulates the cable broadcast signal and transmits the demodulated cable broadcast signal to a TV 320.

The mobile broadcast signal transmitted over the cable broadcasting network 200 is transmitted to a mobile broadcast signal sending device 330. The mobile broadcast signal sending device 330 is set up in a predetermined region, and wirelessly sends the received mobile broadcast signal to that region. The mobile broadcast signal sent from the mobile broadcast signal sending device 330 has a signal strength that covers several to several hundred meters depending on the size of the service area. The mobile broadcast signal sending device 330 has coverage of several meters if set up indoors, or coverage of several hundred meters if set up outdoors. To this end, the mobile broadcast signal sending device 330 may include an amplifier for amplifying a received mobile broadcast signal.

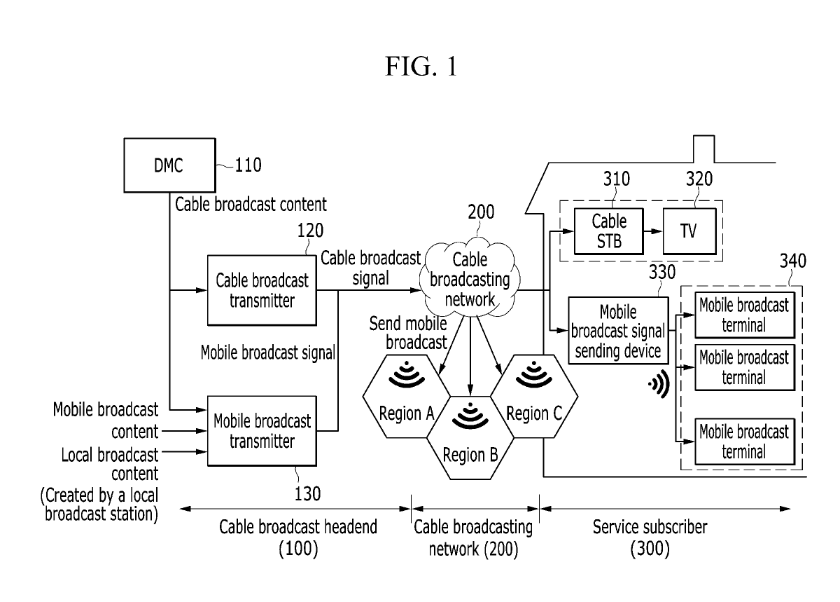

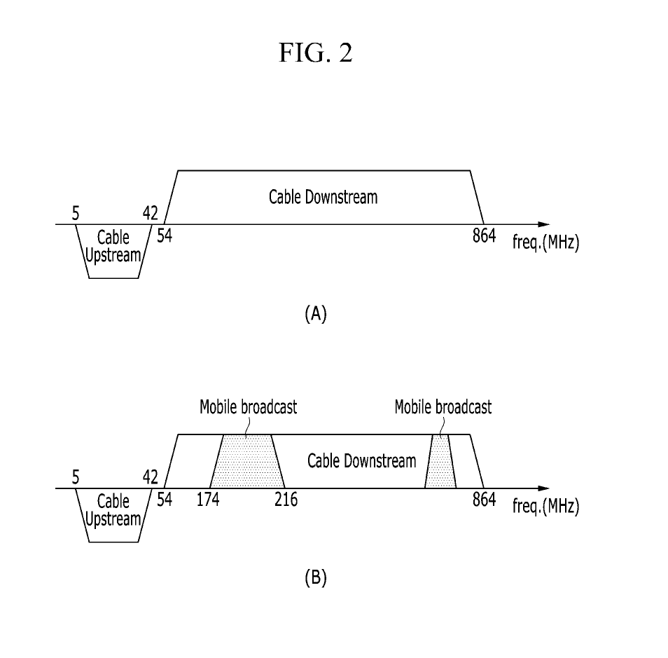

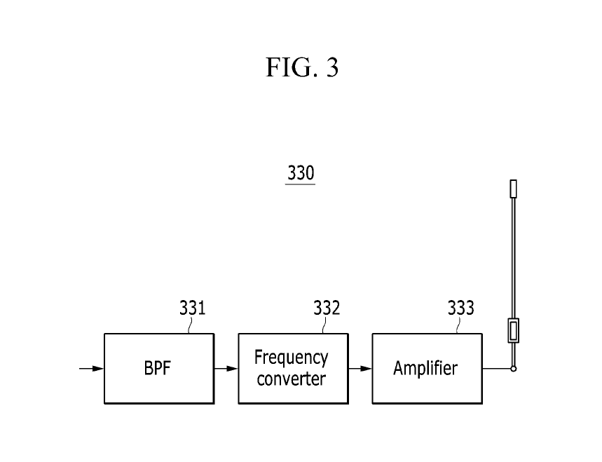

A low-power mobile broadcast signal output by the mobile broadcast signal sending device 330 has to use a different frequency band from that of a general mobile broadcast signal for the corresponding region. To this end, the mobile broadcast signal sending device 330 may include a frequency converter. A concrete configuration of the mobile broadcast signal sending device 330 will be described below in more detail with reference to FIG. 3.

A plurality of mobile broadcast terminals receive a low-power mobile broadcast signal output from the mobile broadcast signal sending device 330, and are provided with a dedicated mobile broadcasting service in a predetermined region. That is, a plurality of mobile broadcast terminals are provided with a mobile broadcasting service sent from the mobile broadcast signal sending device 330, as well as a general mobile broadcasting service.

(A) of FIG. 2 is a view showing a frequency range used in a general cable broadcasting network. (B) of FIG. 2 is a view showing a frequency range that both a cable broadcast signal and a mobile broadcast signal use in a cable broadcasting network 200.

As shown in (A) of FIG. 2, a general cable broadcasting network is capable of two-way transmission, and is divided into Cable Upstream and Cable Downstream. The Cable Upstream is a band for transmitting data from the service subscriber 300 to the cable broadcast headend 100, and a channel for this band is configured to have a predetermined signal bandwidth (1.6 MHz, 3.2 MHz, or 6.4 MHz) in the frequency range of 5 MHz to 42 MHz.

The Cable Downstream is a band for transmitting broadcasting and communications service from the cable broadcasting headend 100 to the service subscriber 300, and has the frequency range of 54 MHz to 864 MHz. Digital broadcasts and cable communication data are transmitted in the Cable Downstream. In the Cable Downstream, each channel is configured to have a bandwidth of 6 MHz, like in terrestrial broadcasting, and a broadcasting or communication service is provided through each channel.

As shown in (B) of FIG. 2, a mobile broadcast signal according to an exemplary embodiment of the present invention uses part of the frequency range of a general cable broadcasting network. That is, the mobile broadcast signal may be sent within the frequency range of 174 MHz to 216 MHz. Channels for the mobile broadcast signal can be configured to have a bandwidth of 6 MHz, like in terrestrial broadcasting. Otherwise, three physical channels may exist within a 6 MHz band, unlike in terrestrial broadcasting. That is, three physical channels: channel 11A (198.512 MHz to 200.048 MHz), channel 11B (200.240 MHz to 201.776 MHz), and channel 11C (201.968 MHz to 203.504 MHz) may exist in a region using channel 11 (198 MHz to 204 MHz). Meanwhile, multiple logical channels may exist in one physical mobile broadcast channel. For example, one physical channel for a mobile broadcasting service may include two logical channels.

In a case where a band (e.g., 174 MHz to 216 MHz) for transmitting a mobile broadcast signal is already in use for cable broadcast service, idle bands may be used instead. The mobile broadcast signal sending device 330 may still require a frequency converter for converting frequencies.

FIG. 3 is a view showing a concrete configuration of a mobile broadcast signal sending device 330 according to an exemplary embodiment of the present invention. As explained above, the mobile broadcast signal sending device 330 according to the exemplary embodiment of the present invention is a system that sends a mobile broadcast signal, which is transmitted over the cable broadcasting network 200, at low power.

As shown in FIG. 3, the mobile broadcast signal sending device 330 according to the exemplary embodiment of the present invention includes a band-pass filter (BPF) 331, a frequency converter 332, and an amplifier 333.

Of a cable broadcast signal and a mobile broadcast signal that are transmitted over the cable broadcasting network 200, the BPF 331 passes only the band of the mobile broadcast signal. That is, the BPF 331 is able to prevent the cable broadcast signal from getting through, but not the mobile broadcast signal. The mobile broadcast signal is obtained by passing only the mobile broadcast signal transmission band from the entire bandwidth of the cable broadcasting network by the BPF 331.

The frequency converter 332 converts the mobile broadcast signal frequency band passed by the BPF 331. As described above, the mobile broadcast signal transmitted over the cable broadcasting network 200 can be transmitted at frequencies other than the mobile broadcast frequency band. In this instance, the frequency converter 332 converts the frequency of the mobile broadcast signal transmitted over the cable broadcasting network into a mobile broadcast frequency band.

The amplifier 333 performs the function of adjusting signal strength depending on the coverage of the mobile broadcast signal sending device 330. The mobile broadcast signal amplified by the amplifier 333 is sent through an antenna.

The mobile broadcast signal sending device 330 according to the exemplary embodiment of the present invention can be set up and used in a subscriber's house or in a certain outdoor area. If set up indoors, the mobile broadcast signal sending device 330 may be connected to a cable broadcasting antenna outlet or embedded in the cable set-top box 310. If set up outdoors, the mobile broadcast signal sending device 330 may amplify signal strength depending on the size of the service area to provide a mobile broadcasting service.

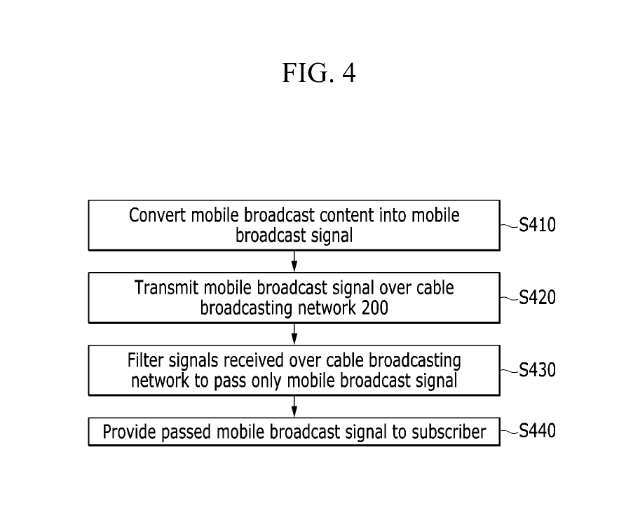

FIG. 4 is a view showing a method for providing a mobile broadcasting service according to an exemplary embodiment of the present invention.

Firstly, the mobile broadcast transmitter 130 converts received mobile broadcast content into a mobile broadcast signal and sends it (410). In this instance, the mobile broadcast transmitter 130 may modulate the signal using the mobile broadcast signal frequency band shown in (B) of FIG. 2.

The obtained mobile broadcast signal is transmitted over a cable broadcasting network 200 (S420). A cable broadcast signal, as well as the mobile broadcast signal, is transmitted over the cable broadcasting network 200.

The mobile broadcast signal sending device 330 filters signals received over the cable broadcasting network 200 to pass only the mobile broadcast signal (S430). In this instance, only the corresponding band is passed by the BPF 331 of the mobile broadcast signal sending device 330.

The mobile broadcast signal sending device 330 provides the subscriber with the mobile broadcast signal passed in S430 (S440). The subscriber in the corresponding region is provided with a mobile broadcasting service using a mobile broadcast terminal 340.

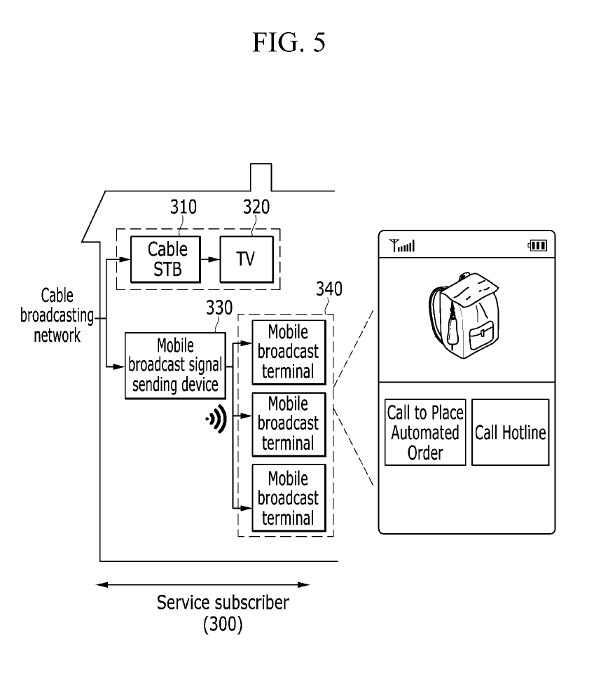

FIG. 5 is a view showing an example of providing a mobile broadcast home shopping service through a mobile broadcasting service provision method according to an exemplary embodiment of the present invention.

A mobile broadcast home shopping service is currently available in large cities, but is not available in some small cities. According to an exemplary embodiment of the present invention, the subscriber can shop while at home as a mobile broadcast signal is sent to the subscriber's house over a cable broadcasting network. Particularly, much greater synergy can be achieved by interfacing the mobile broadcasting service according to the exemplary embodiment of the present invention with home shopping channels on cable television.

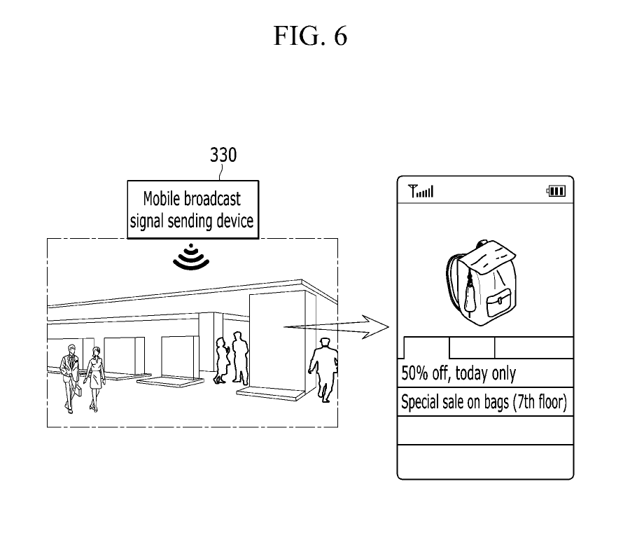

FIG. 6 is a view showing an example of providing a shopping assistance service in a department store or a hypermarket store through a mobile broadcasting service provision method according to an exemplary embodiment of the present invention.

Conventionally, department stores and hypermarket stores have provided shopping information in print. As in the mobile broadcasting service provision method according to the exemplary embodiment of the present invention, a low-power mobile broadcast signal can be sent using a cable broadcasting network. In this instance, the mobile broadcast signal sensing device 330 according to the exemplary embodiment of the present invention is set up in a department store or hypermarket store. The mobile broadcast signal sensing device 330 provides in-store shopping information through a mobile broadcast signal. One mobile broadcast physical channel for the shopping information may include multiple logical channels.

As shown in FIG. 6, when an app provided by the store is run on a mobile broadcast terminal equipped with a mobile broadcast receiver, the mobile broadcast terminal searches through mobile broadcast channels and then displays the corresponding mobile broadcast. Entries for each shopping event can be distinguished by logical channels, and the content of each logical channel may consist of several still pictures or an advertisement at a low transfer rate (1 or 2 frames per second). Such content can be repeatedly transmitted in such a way that the store provides a cable television company with an advertising layout and related materials and the cable company creates mobile broadcast content based on the advertising layout and related materials.

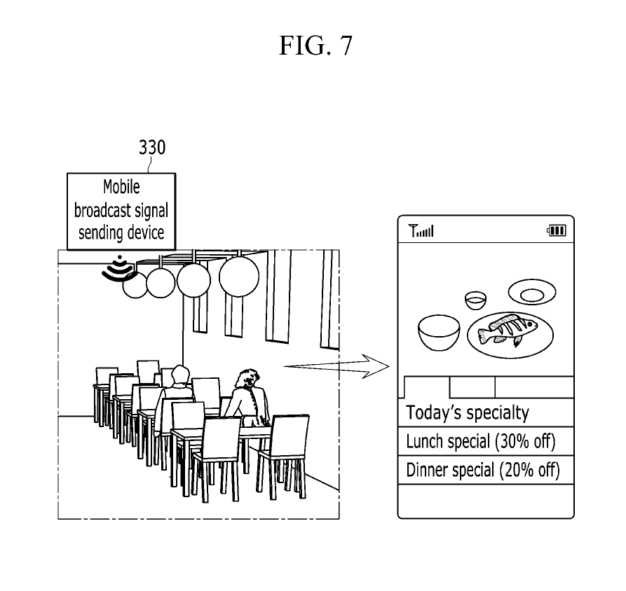

FIG. 7 is a view showing an example of providing a menu guide service in a restaurant through a mobile broadcasting service provision method according to an exemplary embodiment of the present invention.

The menu guide service shown in FIG. 7 is provided in the same manner as the method of FIG. 6, so a detailed description thereof will be omitted.

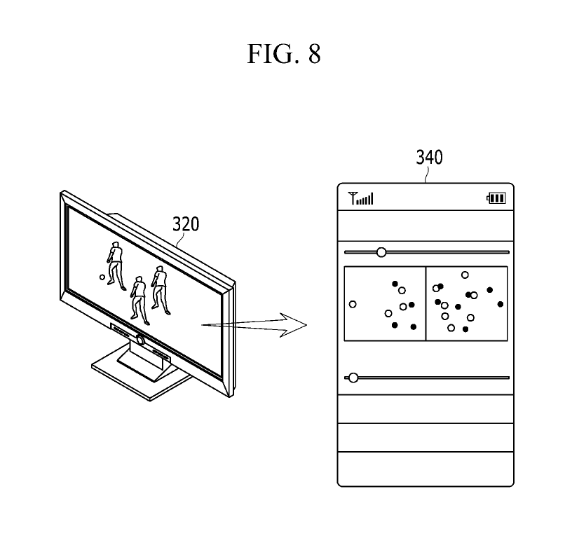

FIG. 8 is a view showing an example of providing a second screen service through a mobile broadcasting service provision method according to an exemplary embodiment of the present invention.

As shown in FIG. 8, a cable broadcast service is provided through the TV 320, and other information related to cable broadcasting is provided through the mobile broadcast terminal 340. For example, the TV 320 may receive a cable broadcast signal and broadcast a soccer match, whereas the mobile broadcast terminal 340 may receive a mobile broadcast signal and broadcast the positions of players in the soccer match.

According to an exemplary embodiment of the present invention, the viewer is provided with special information, interfaced with an advertising service or the like, as well as normal information.

Moreover, the exemplary embodiment of the present invention allows for the provision of a low-power mobile broadcasting service over a cable broadcasting network, which offers a big advantage in terms of cost. As cable broadcasting networks are already set up in most households, a mobile broadcasting service can be provided to every region that one wants.

In terms of frequency utilization, idle terrestrial broadcast frequencies can be utilized, and this provides coverage of mobile broadcast fringe areas, the diversification of mobile broadcast content, and the creation of additional services of cable television like a second service. Moreover, it can be expected that mobile broadcasting will be revitalized by interfacing with home shopping, large shopping malls, local broadcast stations, etc.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a mobile broadcasting service to a terminal, the method comprising:
generating a mobile broadcast signal using mobile broadcast content;
generating a cable broadcast signal using cable broadcast content;
transmitting the mobile broadcast signal and the cable broadcast signal over a cable broadcasting network;
passing the mobile broadcast signal transmitted over the cable broadcasting network; and
providing the passed mobile broadcast signal to the terminal.

2. The method of claim 1, wherein the method further comprises converting the cable broadcast content to generate the mobile broadcast content.

3. The method of claim 1, wherein the mobile broadcast content is directly provided by a program provider.

4. The method of claim 1, wherein the providing of the passed mobile broadcast signal to the terminal comprises:
converting the frequency of the passed mobile broadcast signal;
amplifying the frequency-converted mobile broadcast signal; and
sending the amplified mobile broadcast signal to the terminal.

5. The method of claim 1, wherein the mobile broadcast signal is transmitted using part of the frequency range of the cable broadcasting network.

6. The method of claim 1, wherein the mobile broadcast content comprises in-store shopping information, and the terminal displays the shopping information.

7. The method of claim 1, wherein the mobile broadcast content is information related to the cable broadcast content.

8. An apparatus for providing a mobile broadcasting service, the apparatus comprising:
a cable broadcast transmitter that generates a cable broadcast signal using cable broadcast content; and
a mobile broadcast transmitter that generates a mobile broadcast signal using mobile broadcast content,
wherein the cable broadcast signal and the mobile broadcast signal may be sent over a cable broadcasting network.

9. The apparatus of claim 8, further comprising a mobile broadcast signal sending device that receives the mobile broadcast signal and provides the mobile broadcast signal to a terminal.

10. The apparatus of claim 9, wherein the mobile broadcast signal sending device comprises:
a band-pass filter that filters the cable broadcast signal and the mobile broadcast signal to pass the mobile broadcast signal; and
an amplifier that amplifies the passed mobile broadcast signal.

11. The apparatus of claim 10, wherein the mobile broadcast signal sending device further comprises a frequency converter that converts the frequency of the passed mobile broadcast signal and provides the frequency-converted mobile broadcast signal to the amplifier.

12. The apparatus of claim 8, further comprising a set-top box that receives and demodulates the cable broadcast signal and provides the demodulated cable broadcast signal to a TV.

13. The apparatus of claim 9, wherein the mobile broadcast signal sending device is set up indoors or outdoors.

14. A method for providing a mobile broadcasting service to a terminal, the method comprising:
receiving a mobile broadcast signal and a cable broadcast signal over a cable broadcasting network;
filtering the cable broadcast signal and the mobile broadcast signal to pass the mobile broadcast signal; and
providing the passed mobile broadcast signal to the terminal.

15. The method of claim 14, wherein the cable broadcast signal and the mobile broadcast signal are transmitted at different bands in the frequency range for the cable broadcast network.

16. The method of claim 15, wherein one physical channel for the mobile broadcasting service comprises a plurality of logical channels.
